(19) United States
(12) Patent Application Publication
(10) Pub. No.: US 2023/0093563 A1
(43) Pub. Date: Mar. 23, 2023

(54) ENCAPSULATED PYRETHROIDS WITH IMPROVED EFFICTIVENESS IN SOIL AND LEAF APPLICATIONS

(71) Applicant: Bayer Aktiengesellschaft, Leverkusen (DE)

(72) Inventors: Holger EGGER, Koeln (DE); Gorka PERIS URQUIJO, Koeln (DE); Ralf HAMBROCK, Monheim (DE); Marc Andre RIST, Duesseldorf (DE); Veronica COMPANYS GARCIA, Langenfeld (DE); Bernhard HITZBERGER, Hilden (DE)

(21) Appl. No.: 17/802,104

(22) PCT Filed: Feb. 22, 2021
(86) PCT No.: PCT/EP2021/054290

§ 371 Date: Aug. 24, 2022

(30) Foreign Application Priority Data
Feb. 24, 2020 (EP) 20159164.1

(51) Int. Cl. A01N 53/00; A01N 25/28

(52) U.S. Cl. CPC A01N 53/00; A01N 25/28

(57) ABSTRACT

The present invention relates to aqueous capsule suspensions based on various pyrethroids, to the production thereof and to the use thereof in the form of an agrochemical formulation, especially for soil application.

### TECHNICAL PROBLEM/OBJECT

The present invention relates to aqueous capsule suspensions based on various pyrethroids, to the production thereof and to the use thereof in the form of an agrochemical formulation, especially for soil application.

### PRIOR ART

Pyrethroids are an established class of active substance and are available in a diversity of formulation types for a wide range of uses, such as foliar uses, soil uses, surface treatments, impregnated materials, etc.

Specifically for soil uses there is for example Karate (lambda-cyhalothrin in the form of a GR formulation), Force® (tefluthrin GR) or Belem® (cypermethrin GR), especially against the corn rootworm and similar species. In contrast to these known solid formulations, liquid formulations are in this sector uncommon. However, a disadvantage of solid formulations is that a relatively high application rate is usually necessary alongside low loading of the formulation.

The successful microencapsulation of crop protection active substances has been extensively described in the literature, for example in U.S. Pat. No. 77,608,085, EP0214936. Many documents also explicitly mention pyrethroids as potential active substances, for example U.S. Pat. No. 5,846,554, WO 1997/44125, WO 2016169683, EP183999.

In addition, there is for example on the market a microencapsulated lambda-cyhalothrin (Karate Zeon) and also a deltamethrin formulation (DelCaps CS 050), in each case for foliar uses.

Some patents additionally also mention the potential use of capsule suspensions for soil uses, for example WO2016169683, WO2016202659, in which pyrethroids are also mentioned as potential active substances. There is also scientific literature on the general interaction of microcapsules in soil.

WO2011042495 explicitly mentions for example the improvement in soil mobility of poorly soluble crop protection active substances, inter alia deltamethrin, through the use of polymer particles. However, no biological data are presented in WO2011042495, consequently there is no indication of the relationship between soil mobility, biological activity and/or bioavailability of the active substance. WO 2018/141594 describes the addition of a soil mobilizer to a formulation of a water-insoluble herbicide. The substance is a surfactant of the alkyl C₁-C₃ phenyl ethoxylate type (C₂-C₆-EO)₁₋₁₀₀. The surfactant can be incorporated into the formulation (for example in a SC) or added as a tankmix additive. In addition, WO 2018/141594 also mentions in principle microencapsulated herbicide formulations as a possible formulation that could be used, which again is not backed up with data.

WO 2017/149069 describes polyether-modified short-chain siloxanes as additional adjuvants for soil uses, in order to boost the agronomic yield irrespective of formulation type and physical properties of the active substance.

WO 01/94001 describes microcapsules that additionally comprise a surface-modifying ingredient, including also examples with pyrethroids. The substances are chemically bonded to the microcapsule shell to improve the properties of the capsules in soil. This has been shown to be able to thus improve soil mobility.

Disadvantage of the Prior Art

Although the prior art describes the possibility of providing pyrethroids for soil application in the form of granule formulations, these formulations have only a low active ingredient concentration, consequently a high application rate is necessary, which also results in high stress on the soil due to adjuvants and other formulation auxiliaries.

Also described in the prior art are furthermore various options for providing pyrethroids as liquid formulations in the form of encapsulated formulations. It is however unclear to what extent this is suitable at all for active ingredients with poor soil availability such as deltamethrin that cannot be used in solid formulations for soil uses.

Moreover, there is no formulation described in the prior art that is suitable for both soil and foliar uses; in particular there are no known formulations that allow efficient soil use of deltamethrin.

In summary, it can be stated that the experts in the field are currently of the view that deltamethrin in particular is unsuitable for soil use.

### OBJECT

The object of the present invention was therefore to provide a suitable formulation with the highest possible active ingredient loading and a low application rate that, for pyrethroid active ingredients, but especially for deltamethrin, universally ensures adequate bioavailability coupled with adequate long-term activity for soil uses.

The object was also to provide a formulation that stresses the soil only with a small amount of formulation auxiliaries and inert materials.

The object was additionally to provide a formulation that is suitable for both soil and foliar uses.

### Solution

The object was solved by the capsule suspension concentrates (CS) according to the invention. It was surprisingly found that the formulation according to the invention is universally suitable for soil uses of the pyrethroid class of compounds, irrespective of their physicochemical properties. The CS of the present invention ensure both adequately high availability of the active ingredient and adequate duration of activity. It was surprisingly found that the formulation according to the invention shows good biological activity irrespective of the soil conditions, such as moisture content and proportion of organic matter in soil.

It has also been able to be demonstrated that the capsule suspension according to the invention is suitable also for foliar uses.

### Detailed Invention

The present invention therefore provides capsule suspension concentrates comprising
A) a particulate disperse phase comprising
   1) a reaction product of at least one compound having isocyanate-reactive groups a1.1) and an isocyanate or isocyanate mixture a1.2)
   2) a pyrethroid a2.1) in an organic, water-insoluble solvent a2.2),
   3) one or more additives a3.1) and
B) a liquid aqueous phase comprising at least one protective colloid b1.1) and also
   optionally further additives b1.2),
      wherein the particles of the disperse phase A) preferably have a median particle size of between 1 and 50 μm
      and wherein
      the proportion of a1.2) is between 0.1% and 2% by weight,
      the proportion of agrochemical active ingredient a2.1) is between 1% and 50% by weight,
      the proportion of organic solvent a2.2) is between 1% and 90% by weight,
      the proportion of additive a3.1) is between 0.5% and 5% by weight,
      the proportion of protective colloids b1.1) is between 0.1% and 5% by weight, and
      the proportion of additives b1.2) is between 0.1% and 15% by weight.

When a1.1. is not an added amine or alcohol, a.1.1 is the amine liberated by hydrolysis of the isocyanate.

Compounds according to a1.1. may also be referred to as crosslinkers. Crosslinkers are thus for the purposes of the present invention compounds according to all, unless otherwise defined.

The present invention also provides for the use of the capsule suspensions according to the invention for the use in soil of pyrethroids and of deltamethrin in particular.

The particle size is determined according to CIPAC (CIPAC=Collaborative International Pesticides Analytical Council; www.cipac.org) Method MT 187. In this method, the particle size distribution is determined by laser diffraction. For this, a representative amount of sample is dispersed in degassed water at ambient temperature (self-saturation of the sample), sonicated (normally for 60 s) and then measured in a Malvern Mastersizer series instrument. The scattered light is measured at various angles with the aid of a multi-element detector and the associated numerical values are recorded. The proportion of particular size classes is calculated from the scattering data with the aid of the Fraunhofer model and a volume-weighted particle size distribution calculated therefrom. The reported values are normally the d50 and d90 values=particle size of active ingredient (50% and 90% of all volume particles). The median particle size refers to the d50 value.

The particles of the disperse phase A) have a particle size d50 that is preferably between 1 and 50 μm (micrometres), particularly preferably between 1 and 20 μm and very particularly preferably between 2 and 15 μm.

The present invention likewise provides a process for producing the capsule suspension concentrates according to the invention, characterized by the following process steps:
I. producing the organic phase A)
II. producing the aqueous phase B)
III. producing an emulsion of A) in B)
IV. optionally adding component a1.1) (when a1.1. is not water)
V. step of heating
VI. finalizing.

In step (I), the active ingredient a2.1) and the further additives a3.1) are dissolved in the organic solvent a2.2) while stirring. Step (I) of the process according to the invention is generally carried out at temperatures between 0° C. and 80° C., preferably between 0° C. and 50° C. and more preferably between 2° C. and 40° C. The isocyanate a1.2) is then added to the resulting mixture. The addition can for example take place by direct addition to the mixtures or by continuous metering in with the aid of apparatus customary for purposes of this kind such as a static mixer, the addition taking place shortly before combining with the aqueous phase B).

In step (II), at least one protective colloid b1.1) and optionally further additives b1.2) are dissolved in water while stirring. This generally takes place at temperatures between 0° C. and 80° C., preferably between 15° C. and 80° C.

In step (III), the organic phase A) is added to the aqueous phase B) and an emulsion is produced. It is possible to use for the production thereof all apparatuses customary for purposes of this kind that generate strong shear forces. Examples include rotor/stator mixers and jet dispersers. Step (III) is generally carried out at temperatures between 0° C. and 80° C., preferably between 10° C. and 75° C. The production of the emulsion can take place either batchwise or continuously.

In step (IV) of the process according to the invention, the emulsion obtained from step (III) is admixed in step (IV) with a diamine, polyamine, diol, polyol and/or amino alcohol a1.1) while stirring. The amine or alcohol components a1.1) are here expediently added in aqueous solution. In the process according to the invention, preference is however given to using exclusively water as component a1.1), which, as already mentioned above, is understood as meaning in the context of the present invention that component a1.1. is formed through hydrolysis of the isocyanate with water. “Water” here thus means the hydrolysis product (amine).

In step (V), the mixture is heated for a certain time while stirring, to ensure the reaction has gone to completion. The period of time is generally from 0 to 24 hours, preferably 0.5 to 8 hours, more preferably 1 to 5 hours, with the reaction preferably being carried out at temperatures between 0° C. and 80° C., preferably between 20° C. and 75° C.

In step (VI), the capsule suspension is at the end of the reaction that results in capsule formation brought to room temperature and then optionally admixed further with additives b1.2) while stirring. The additives b1.2) may in principle be added in step (II) or step (VI) as required.

The process according to the invention is preferably carried out under atmospheric pressure.

In the performance of the process according to the invention, the ratio of NCO groups from component a1.2) to NCO-reactive groups from component a1.1) may be varied within a particular range. Preferably, 0 to 1.5 equivalents of added amine or alcohol component is used per 1 mol of isocyanate. Preferably, no crosslinker is used, i.e. a1.1) forms through hydrolysis of the isocyanate with water (or is “water” according to the above definition).

In an alternative embodiment, 0.1 to 1.5 equivalents of added amine or alcohol component is used per 1 mol of isocyanate.

From the amount of the shell-forming ingredients a1.1) and a.1.2) used and the resulting particle size, it is possible to calculate a theoretical wall thickness of the capsules from the median particle size (d50) of the capsules and the amount of shell-forming materials used, the density of the polymer being set at 1 (1 g/cm³). This calculated wall thickness in the capsules of the capsule suspension concentrates according to the invention is preferably between 0.001 and 4 μm, more preferably between 0.01 and 2 μm and particularly preferably between 0.01 and 1 μm.

In the reaction of all) with a1.2), the total of the number-average functionality X of isocyanate groups and isocyanate-reactive groups is 2≤X≤6, preferably 2≤X≤4.5, particularly preferably 2.0≤X≤3.5 and very particularly preferably 2.2≤X≤2.8.

The “number-average functionality X” as a feature in the process according to the invention is illustrated as follows. It is the compound of higher functionality that is key here; the value obtained by subtracting 2 from the compound of lower functionality is added to the compound of higher functionality. For example, if the (average) functionality of a1.1) is 2.1 and that of a1.2) is 2.6, this gives: 2.1−2=0.1. This difference is added to 2.6: 2.6+0.1=2.7. The number-average functionality is thus 2.7. Alternatively, if a1) is 2.7 and a2) is 2.3, the resulting number-average functionality is 2.7+2.3−2=3.0.

Useful compounds having isocyanate-reactive group a1.1) include aliphatic, aromatic, cyclic and alicyclic primary and secondary diamines, and also polyamines. Examples include ethylenediamine (EDA), diethylenetriamine (DETA), monoisopropylamine, 4-aminopyridine (4-AP), n-propylamine, ethylene- or propylenimine-based polyaziridine, triethylenetetraamine (TETA), tetraethylenepentamine, 2,4,4′-triaminodiphenyl ether, bis(hexamethylene)triamine, trimethylenedipiperidine (TMDP), guanidine carbonate (GUCA), phenylenediamine, toluenediamine, pentamethylenehexamine, 2,4-diamino-6-methyl-1,3,5-triazine, 1,2-diaminocyclohexane, 4,4′-diaminodiphenylmethane, 1,5-diaminonaphthalenisophoronediamine, diaminopropane, diaminobutane, piperazine, aminoethylenepiperazine (AEP), polypropylene glycol) bis(2-aminopropyl ether) or o,o′-bis(2-aminopropyl)polypropylene glycol-block-polyethylene glycol-block-polypropylene glycol, hexamethylenediamine, bis(3-aminopropyl)amine, bis(2-methylaminoethyl)methylamine, 1,4-diaminocyclohexane, 3-amino-1-methylaminopropane, N-methylbis(3-aminopropyl)amine, 1,4-diamino-n-butane and 1,6-diamino-n-hexane. Preference is given to hexamethylenediamine and diethylenetriamine.

Useful compounds having isocyanate-reactive group a1) likewise include primary and secondary, aliphatic and aromatic diols and polyols. Examples include: ethanediol, propanediol (1,2), propanediol (1,3), butanediol (1,4), pentanediol (1,5), hexanediol (1,6), glycerol and diethylene glycol. Preference is given to using glycerol and propane-1,2-diol.

Compounds having isocyanate-reactive group a1.1) also include amino alcohols. Examples include triethanolamine, monoethanolamine, triisopropanolamine, diisopropylamine, N-methylethanolamine, N-methyldiethanolamine.

In a very particularly preferred embodiment, water is exclusively used as isocyanate-reactive component a1.1). This reacts in situ with the isocyanate (poly/di) to give an amine (poly/di) that is itself then isocyanate-reactive.

It is likewise possible to use blends of a1.1).

The isocyanate or isocyanate mixture a1.2) is a mono-, di- and/or polyisocyanate mixture, or a reaction product of isocyanate mixtures. Suitable compounds a1.2) are, for example, butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes (H12-MDI) and mixtures thereof with any isomer content, cyclohexylene 1,4-diisocyanate, 4-isocyanatomethyloctane 1,8-diisocyanate (nonane triisocyanate), phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI), 1,3- and/or 1,4-bis(2-isocyanatoprop-2-yl)benzene (TMXDI), 1,3-bis (isocyanatomethyl)benzene (XDI), alkyl 2,6-diisocyanatohexanoates (lysine diisocyanates) with alkyl groups having 1 to 8 carbon atoms, and mixtures thereof. Compounds containing modifications such as allophanate, uretdione, urethane, isocyanurate, biuret, iminooxadiazinedione or oxadiazinetrione structure and based on said diisocyanates are also suitable structural units for component a1.2), as also are multiring compounds, for example polymeric MDI (pMDI, for instance PAPI-27 from Dow or Desmodur® 44V20 products from Covestro AG) and combinations of the above.

Preference is given to using modifications having an isocyanate (NCO) functionality of 2 to 6, preferably of 2.0 to 4.5 and particularly preferably of 2.3 to 4.2 and very particularly preferably of 2.3 to 3.8. Especially preferred is an NCO functionality of 2.4 to 3.

Preference is given to modification using diisocyanates from the group HDI, IPDI, H12-MDI, TDI and MDI. Particular preference is given to HDI, TDI and MDI and to derivatives thereof. Especially preferably, MDI is used in the form of polymeric MDI, for example PAPI-27.

The preferred NCO content of the isocyanate or polyisocyanate or blend is between 3% and 50% by weight, particularly preferably between 10% and 40% by weight, particularly preferably between 15% and 35% by weight and very particularly preferably between 20% and 35% by weight. The isocyanate groups may also be present in partially or completely blocked form prior to their reaction with the isocyanate-reactive groups, in such a way that they cannot react immediately with the isocyanate-reactive group. This ensures that the reaction does not take place until a particular temperature (blocking temperature) has been reached. Typical blocking agents can be found in the prior art and are selected such that they are eliminated again from the isocyanate group at temperatures between 60 and 220° C., depending on the substance, and only then react with the isocyanate-reactive group. There are blocking agents that become incorporated into the polyurethane and also ones that remain as solvents or plasticizers in the polyurethane or are evolved as gases from the polyurethane. The expression “blocked NCO values” is sometimes used. When the expression “NCO values” is used in the invention, this always refers to the unblocked NCO value. The usual extent of blocking is up to <0.5%. Examples of typical blocking agents are caprolactam, methyl ethyl ketoxime, pyrazoles, for example 3,5-dimethyl 1,2-pyrazole or pyrazole, triazoles, for example 1,2,4-triazole, diisopropylamine, diethyl malonate, diethylamine, phenol and derivatives thereof, and imidazole.

Component a1.2) may also be used in the form of a mixture of the above compounds or else of a prepolymer. In this case, by way of example, a compound containing isocyanate groups and having an NCO content of between 3% and 50% by weight is reacted with compounds containing isocyanate-reactive groups and having an OH value of between 10 mg KOH/g and 150 mg KOH/g.

Particular preference is given to using just one isocyanate and no mixture.

Useful organic solvents a2.2) include all customary organic solvents that are immiscible with water (phase separation), but readily dissolve the employed agrochemical active ingredients. Preferred examples include aliphatic and aromatic, optionally halogenated, hydrocarbons such as toluene, xylene, Solvesso 100, 100ND, 150, 150 ND or 200, 200 ND (mineral oil), tetrachloromethane, chloroform, methylene chloride and dichloroethane, and also esters such as ethyl acetate, and alkanecarboxamides such as N,N-dimethyloctanamide and N,N-dimethyldecanamide. Also come vegetable oils and modified oils (for example by methylation, ethylation and also hydrogenation and hydration) based for example on rapeseed oil, maize kernel oil, coconut oil or the like. Particular preference is given to using mineral oil, very particular preference to using solvents based on a dialkyl naphthalene (for example diisopropylnaphthalene), and also mixtures of 1-methyl- and 2-methylnaphthalene and naphthalene (for example Solvesso 200 ND products, CAS No.: 64742-94-5).

A mixture of organic solvents a2.2) may in principle also be used. Preference is given to using just one solvent.

Useful further additives a3.1) include all oil-soluble surface-active additives. Particular preference is given to alkyl ethoxylates, alkyl propoxy ethoxylates, fatty acid esters of sorbitan and glycerol, and organomodified trisiloxanes. Very particular preference is given to alkyl ethoxylates and alkyl propoxy ethoxylates. Especially preferred are alkyl ethoxylates and alkyl propoxy ethoxylates having a terminal hydroxyl function. Examples include Break-Thru® Vibrant, Synergen W 06, Genapol EP 2584 and Genapol X 060.

The aqueous phase B) of the capsule suspension concentrates according to the invention comprises in addition to water at least one protective colloid b1.1) and may comprise further additives b1.2) such as emulsifiers, preservatives, defoamers, cold stabilizers, thickeners, pH stabilizers and neutralizing agents.

Useful protective colloids b1.1) (emulsifiers for disperse phase A) include all substances typically used for this purpose. Preferred examples include natural and synthetic water-soluble polymers such as gelatins, starch and cellulose derivatives, especially cellulose esters and cellulose ethers, such as methyl cellulose, and also polyvinyl alcohols, partially hydrolysed polyvinyl acetates (degree of saponification <98%), lignosulfonates (such as Borresperse® NA, REAX® 88 or Kraftsperse 25 S), modified naphthalenesulfonates (for instance Morwet® D-425), polyvinylpyrrolidones and polyacrylamides. Particular preference is given to using polyvinyl alcohols, partially hydrolysed polyvinyl acetates, and lignosulfonates. Very particular preference is given to polyvinyl alcohols, partially hydrolysed polyvinyl acetates, and lignosulfonates.

Useful thickeners b1.2) include organic thickeners and inorganic thickeners. Useful organic thickeners include organic natural or biotechnologically modified or organic synthetic thickeners. Typical synthetic thickeners are Rheostrux® (Croda) and the Thixin or Thixatrol series (Elementis). These are typically based on acrylates. Typical organic thickeners are based on xanthan or cellulose (for instance hydroxyethyl cellulose or carboxymethyl cellulose) or a combination thereof. Further typical representatives are based on cellulose or lignin. Preference is given to using natural modified thickeners based on xanthan Typical representatives are, for example, Rhodopol® (Solvay) and Kelzan® (Kelco Corp.), and also Satiaxane® (Cargill). Inorganic thickeners are typically based on silicas or clay minerals.

Useful preservatives b1.2) include all substances typically present for this purpose in crop protection compositions, for example dichlorophen, benzyl alcohol hemiformal, 5-chloro-2-methyl isothiazolin-3-one [CAS No. 26172-55-4], 2-methyl-4-isothiazolin-3-one [CAS No. 2682-20-4] or 1.2-benzisothiazol-3(2H)-one [CAS No. 2634-33-5]. Examples include Acticide SPX (Thor), Proxel GXL (Lonza), Preventol D7 or Kathon CG/ICP.

Useful defoamers b1.2) include all substances typically usable for this purpose in crop protection compositions. Preference is given to silane derivatives, such as polydimethylsiloxanes, and magnesium stearate. Silcolapse® 484, 426 R, SRE (Solvay, Silioxane Emulsion) and SAG® 1571 (Momentive) are used as typical products.

Substances that act as cold stabilizers b1.2) may be any such substances typically usable for this purpose in crop protection compositions. Examples include urea, glycerol and propylene glycol.

Useful neutralizing agents b1.2) include customary acids and bases. Examples include phosphoric acid, citric acid, sodium hydroxide solution and aqueous ammonia solution.

The composition of the capsule suspension concentrates according to the invention can be varied within a particular range. The proportion of the disperse phase A) based on the overall formulation is generally between 10% and 90% by weight, preferably between 30% and 70% by weight, more preferably between 40% and 60% by weight.

The proportion of a1.2) based on the overall formulation is generally between 0.1% and 8% by weight, preferably between 0.2% and 4.5% by weight and more preferably between 0.5% and 4% by weight.

In an alternative preferred embodiment, the proportion of a1.2) based on the overall formulation is generally between 0.1% and 2% by weight, preferably between 0.2% and 2% by weight and more preferably between 0.5% and 2% by weight.

The proportion of the agrochemical active ingredient a2.1) based on the overall formulation is generally between 1% and 50% by weight, preferably between 5% and 40% by weight and more preferably between 5% and 15% by weight.

The proportion of the organic solvent a2.2) based on the overall formulation is generally between 1% and 90% by weight, preferably between 10% and 60% by weight and more preferably between 25% and 40% by weight.

The proportion of additives a3.1) based on the overall formulation is generally between 0.1% and 10% by weight, preferably between 0.5% and 5% by weight, more preferably between 1% and 5% by weight, very particularly preferably between 2% and 5% by weight.

The proportion of protective colloid b1.1) based on the overall formulation is generally between 0.1% and 5% by weight, preferably between 0.2% and 3% by weight and more preferably between 0.2% and 1% by weight and the proportion of additives b1.2) is generally between 0.1% and 15% by weight, preferably between 0.2% and 10% by weight and more preferably between 0.3% and 3% by weight.

The ratio of a1.2) to the total organic phase A) is preferably 40:1 to 60:1, more preferably 45:1 to 60:1 and particularly preferably 45:1-55:1. Provided that all) in the organic phase A) is water, the water required for reaction with the isocyanate does not count towards the organic phase.

With regard to the abovementioned proportions of the respective ingredients, it will be clear to those skilled in the art that the preferred ranges for the individual ingredients may be freely combined with one another, consequently these compositions having different preferred ranges for individual ingredients are considered to be disclosed too.

Unless otherwise stated, particular preference is however given to preferred ranges of the same level, i.e. for example all preferred or more preferred ranges, a specific disclosure being intended not to replace these general combinations, but to add to them.

The same applies to other specifications of preferred ranges elsewhere in the present description.

In a preferred embodiment, the proportion of a1.2) is between 0.1% and 8% by weight,

the proportion of agrochemical active ingredient a2.1) is between 1% and 50% by weight,
the proportion of organic solvent a.2.2) is between 1% and 90% by weight,
the proportion of additive a3.1) is between 0.1% and 10% by weight,
the proportion of protective colloids b1.1) is between 0.1% and 5% by weight
and the proportion of additives b1.2) is between 0.1% and 15% by weight.

In an alternative embodiment, the proportion of a1.2) is between 0.2% and 4.5% by weight,

the proportion of agrochemical active ingredient a2.1) is between 5% and 40% by weight,
the proportion of organic solvent a.2.2) is between 10% and 60% by weight,
the proportion of additive a3.1) is between 0.5% and 5% by weight,
the proportion of protective colloids b1.1) is between 0.2% and 3% by weight
and the proportion of additives b1.2) is between 0.2% and 10% by weight.

In an alternative embodiment, the proportion of a1.2) is between 0.5% and 4.0% by weight,

the proportion of agrochemical active ingredient a2.1) is between 5% and 15% by weight,
the proportion of organic solvent a.2.2) is between 25% and 40% by weight,
the proportion of additive a3.1) is between 2% and 5% by weight,
the proportion of protective colloids b1.1) is between 0.2% and 1% by weight
and the proportion of additives b1.2) is between 0.3% and 3% by weight.

In a preferred embodiment, the proportion of a1.2) is between 0.1% and 2% by weight,

the proportion of agrochemical active ingredient a2.1) is between 1% and 50% by weight,
the proportion of organic solvent a.2.2) is between 1% and 90% by weight,
the proportion of additive a3.1) is between 0.5% and 5% by weight,
the proportion of protective colloids b1.1) is between 0.1% and 5% by weight
and the proportion of additives b1.2) is between 0.1% and 15% by weight.

In an alternative embodiment, the proportion of a1.2) is between 0.2% and 2% by weight,

the proportion of agrochemical active ingredient a2.1) is between 5% and 40% by weight,
the proportion of organic solvent a.2.2) is between 10% and 60% by weight,
the proportion of additive a3.1) is between 1% and 5% by weight,
the proportion of protective colloids b1.1) is between 0.2% and 3% by weight
and the proportion of additives b1.2) is between 0.2% and 10% by weight.

In an alternative embodiment, the proportion of a1.2) is between 0.5% and 2% by weight,

the proportion of agrochemical active ingredient a2.1) is between 5% and 15% by weight,
the proportion of organic solvent a.2.2) is between 25% and 40% by weight,
the proportion of additive a3.1) is between 2% and 5% by weight,
the proportion of protective colloids b1.1) is between 0.2% and 1% by weight
and the proportion of additives b1.2) is between 0.3% and 3% by weight.

Preferably, the ratio of agrochemical active ingredient a2.1) to the isocyanate or isocyanate mixture a1.2) is between 1:1 and 30:1, preferably between 1:1 and 15:1, more preferably between 2:1 and 10:1.

When amino-functional compounds are used as component all), the ratio of aminic isocyanate-reactive groups all) to the isocyanate mixture a1.2) is between 0 and 1.5, preferably between 0 and 1, more preferably between 0 and 0.5, particularly preferably between 0 and 0.3. Very particularly preferably, it is 0, i.e. no amino-functional compounds a1.1) are used, with water instead serving as the isocyanate-reactive component.

In addition, the organic solvent a2.2) is in the abovementioned embodiments preferably a mineral oil, more preferably a solvent based on a dialkyl naphthalene (for example diisopropylnaphthalene), and a mixture of 1-methyl- and 2-methylnaphthalene and naphthalene (for example Solvesso 200 ND products, CAS No.: 64742-94-5), with very particular preference given to a mixture of 1-methyl- and 2-methylnaphthalene and naphthalene as solvent.

It is in principle possible to mix the formulation according to the invention with further formulations in order to combine two or more active ingredients. For example, the present invention may be combined with water-based formulations such as an SC, SL or a further CS.

Pyrethroids are synthetic insecticides based on the principal active substances present in the natural insecticide.

Preference is given to suitable pyrethroids selected from the group comprising acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomer], deltamethrin, empenthrin [(EZ)-(1R) isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans isomer], prallethrin, pyrethrins (pyrethrum), resmethrin, silafluofen, tefluthrin, tetramethrin, tetramethrin [(1R) isomer], tralomethrin, transfluthrin and methoxychlor.

Greater preference is given to deltamethrin, beta-cyfluthrin, cypermethrin and lambda-cyhalothrin and particular preference to deltamethrin.

In addition, the capsule suspension concentrates may in an alternative embodiment comprise further insecticides, acaricides and/or nematicides, for example also as a result of the above-described mixing with another formulation.

Insecticides, acaricides and/or nematicides that can be used in the context of the present invention, here generally referred to by their common name, are known and are described for example in “The Pesticide Manual”, 16th ed., British Crop Protection Council 2012, or can be searched for on the Internet (e.g. http://www.alanwood.net/pesticides). The classification is based on the IRAC Mode of Action Classification Scheme applicable at the time of filing of this patent application.

(1) Acetylcholinesterase (AChE) inhibitors, preferably carbamates selected from alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates selected from acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl-O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel blockers, preferably cyclodiene-organochlorines selected from chlordane and endosulfan, or phenylpyrazoles (fiproles) selected from ethiprole and fipronil.

(4) Competitive modulators of the nicotinic acetylcholine receptor (nAChR), preferably neonicotinoids selected from acetamiprid, clothianidin, dinotefuran, imidacloprid, nitenpyram, thiacloprid and thiamethoxam, or nicotine, or sulfoximines selected from sulfoxaflor, or butenolides selected from flupyradifurone, or mesoionics selected from triflumezopyrim.

(5) Nicotinic acetylcholine receptor (nAChR) allosteric modulators, preferably spinosyns selected from spinetoram and spinosad.

(6) Glutamate-gated chloride channel (GluCl) allosteric modulators, preferably avermectins/milbemycins selected from abamectin, emamectin benzoate, lepimectin and milbemectin.

(7) Juvenile hormone mimics, preferably juvenile hormone analogues selected from hydroprene, kinoprene and methoprene, or fenoxycarb or pyriproxyfen.

(8) Miscellaneous nonspecific (multi-site) inhibitors, preferably alkyl halides selected from methyl bromide and other alkyl halides; or chloropicrin or sulfuryl fluoride or borax or tartar emetic or methyl isocyanate generators selected from diazomet and metam.

(9) Chordotonal organ TRPV channel modulators selected from pymetrozine and pyrifluquinazon.

(10) Mite growth inhibitors selected from clofentezine, hexythiazox, diflovidazin and etoxazole.

(11) Microbial disruptors of insect midgut membrane selected from Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins selected from Cry1Ab, Cry1Ac, Cry1Fa, Cry1A.105, Cry2Ab, VIP3A, mCry3A, Cry3Ab, Cry3Bb and Cry34Ab1/35Ab1.

(12) Inhibitors of mitochondrial ATP synthase, preferably ATP disruptors selected from diafenthiuron, or organotin compounds selected from azocyclotin, cyhexatin and fenbutatin oxide, or propargite or tetradifon.

(13) Uncouplers of oxidative phosphorylation via disruption of the proton gradient selected from chlorfenapyr, DNOC and sulfluramid.

(14) Nicotinic acetylcholine receptor channel blockers selected from bensultap, cartap hydrochloride, thiocyclam, and thiosultap-sodium.

(15) Inhibitors of chitin biosynthesis, type 0, selected from bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, selected from buprofezin.

(17) Moulting disruptors (especially in the case of Diptera) selected from cyromazine.

(18) Ecdysone receptor agonists selected from chromafenozide, halofenozide, methoxyfenozide and tebufenozide.

(19) Octopamine receptor agonists selected from amitraz.

(20) Mitochondrial complex III electron transport inhibitors selected from hydramethylnon, acequinocyl and fluacrypyrim.

(21) Mitochondrial complex I electron transport inhibitors, preferably METI acaricides selected from fenazaquin, fenpyroximate, pyrimidifen, pyridaben, tebufenpyrad and tolfenpyrad, or rotenone (Derris).

(22) Voltage-dependent sodium channel blockers selected from indoxacarb and metaflumizone.

(23) Inhibitors of acetyl-CoA carboxylase, preferably tetronic and tetramic acid derivatives selected from spirodiclofen, spiromesifen and spirotetramat.

(24) Mitochondrial complex IV electron transport inhibitors, preferably phosphines selected from aluminium phosphide, calcium phosphide, phosphine and zinc phosphide, or cyanides selected from calcium cyanide, potassium cyanide and sodium cyanide.

(25) Mitochondrial complex II electron transport inhibitors, preferably beta-ketonitrile derivatives selected from cyenopyrafen and cyflumetofen, or carboxanilides selected from pyflubumide.

(28) Ryanodine receptor modulators, preferably diamides selected from chlorantraniliprole, cyantraniliprole and flubendiamide

(29) Chordotonal organ modulators (with undefined target structure) selected from flonicamid.

(30) Further active compounds selected from acynonapyr, afidopyropen, afoxolaner, azadirachtin, benclothiaz, benzoximate, benzpyrimoxan, bifenazate, broflanilide, bromopropylate, chinomethionat, chloroprallethrin, cryolite, cyclaniliprole, cycloxaprid, cyhalodiamide, dicloromezotiaz, dicofol, dimpropyridaz, epsilon metofluthrin, epsilon momfluthrin, flometoquin, fluazaindolizine, fluensulfone, flufenerim, flufenoxystrobin, flufiprole, fluhexafon, fluopyram, flupyrimin, fluralaner, fluxametamide, fufenozide, guadipyr, heptafluthrin, imidaclothiz, iprodione, isocycloseram, kappa bifenthrin, kappa tefluthrin, lotilaner, meperfluthrin, oxazosulfyl, paichongding, pyridalyl, pyrifluquinazon, pyriminostrobin, spirobudiclofen, spiropidion, tetramethylfluthrin, tetraniliprole, tetrachlorantraniliprole, tigolaner, tioxazafen, thiofluoximate and iodomethane; additionally preparations based on Bacillus firmus (I-1582, BioNeem, Votivo), and the following compounds: 1-{2-fluoro-4-methyl-5-[(2,2,2-trifluoroethyl)sulfinyl]phenyl}-3-(trifluoromethyl)-1H-1,2,4-triazole-5-amine (known from WO2006/043635) (CAS 885026-50-6), {1′-[(2E)-3-(4-chlorophenyl)prop-2-en-1-yl]-5-fluorospiro[indole-3,4′-piperidine]-1(2H)-yl}(2-chloropyridin-4-yl)methanone (known from WO2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010052161) (CAS 1225292-17-0), 3-(4-chloro-2,6-dimethylphenyl)-8-methoxy-2-oxo-1,8-diazaspiro[4.5]dec-3-en-4-yl ethylcarbonate (known from EP 2647626) (CAS-1440516-42-6), 4-(but-2-yn-1-yloxy)-6-(3,5-dimethylpiperidin-1-yl)-5-fluoropyrimidine (known from WO2004/099160) (CAS 792914-58-0), PF1364 (known from JP2010/018586) (CAS Reg. No. 1204776-60-2), (3E)-3-[1-[(6-chloro-3-pyridyl)methyl]-2-pyridylidene]-1,1,1-trifluoropropan-2-one (known from WO2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)benzamide, 4-[5-(3,5-dichlorophenyl)-4,5-dihydro-5-(trifluoromethyl)-3-isoxazolyl]-2-methyl-N-(trans-1-oxido-3-thietanyl)benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethyl-3-[(3,3,3-trifluoropropyl)sulfinyl]propanamide, (+)-N-[3-chloro-1-(3-pyridinyl)-1H-pyrazol-4-yl]-N-ethyl-3-[(3,3,3-trifluoropropyl)sulfinyl]propanamide and (−)-N-[3-chloro-1-(3-pyridinyl)-1H-pyrazol-4-yl]-N-ethyl-3-[(3,3,3-trifluoropropyl)sulfinyl]propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide (liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxy]phenoxy]propoxy]-2-methoxy-6-(trifluoromethyl)pyrimidine (known from CN 101337940 A) (CAS 1108184-52-6); (2E)- and 2(Z)-2-[2-(4-cyanophenyl)-1-[3-(trifluoromethyl)phenyl]ethylidene]-N-[4-(difluoromethoxy)phenyl]hydrazinecarboxamide (known from CN 101715774 A) (CAS 1232543-85-9); cyclopropanecarboxylic acid 3-(2,2-dichloroethenyl)-2,2-dimethyl-4-(1H-benzimidazol-2-yl)phenyl ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethylphenoxy)-3-(6-trifluoromethylpyridazin-3-yl)-3-azabicyclo[3.2.1]octane (CAS 1253850-56-4), (8-anti)-8-(2-cyclopropylmethoxy-4-trifluoromethylphenoxy)-3-(6-trifluoromethylpyridazin-3-yl)-3-azabicyclo[3.2.1]octane (CAS 933798-27-7), (8-syn)-8-(2-cyclopropylmethoxy-4-trifluoromethylphenoxy)-3-(6-trifluoromethylpyridazin-3-yl)-3-azabicyclo[3.2.1]octane (known from WO 2007040280 A1, WO 2007040282 A1) (CAS 934001-66-8), N-[3-chloro-1-(3-pyridinyl)-1H-pyrazol-4-yl]-N-ethyl-3-[(3,3,3-trifluoropropyl)thio]propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]pyrimidine (known from WO 2013/115391 A1) (CAS 1449021-97-9), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), ethyl 3-(4-chloro-2,6-dimethylphenyl)-8-methoxy-1-methyl-2-oxo-1,8-diazaspiro[4.5]dec-3-en-4-yl-carboxylate (known from WO 2010/066780 A1, WO 2011151146 A1) (CAS 1229023-00-0), 4-[(5S)-5-(3,5-dichloro-4-fluorophenyl)-4,5-dihydro-5-(trifluoromethyl)-3-isoxazolyl]-N-[(4R)-2-ethyl-3-oxo-4-isoxazolidinyl]-2-methylbenzamide (known from WO 2011/067272, WO2013/050302) (CAS 1309959-62-3).

Crop Protection—Types of Treatment

The plants and plant parts are treated with the capsule suspensions in accordance with the present invention directly or through action on their surroundings, habitat or storage space using the customary treatment methods, for example by dipping, spraying, atomizing, sprinkling, vaporizing, dusting, misting, broadcasting, foaming, painting, spreading-on, injecting, watering (drenching), drip irrigating and, in the case of propagation material, in particular in the case of seed, additionally by dry seed treatment, liquid seed treatment, slurry treatment, by incrusting, by coating with one or more coats, etc. It is further possible to apply the capsule suspensions in accordance with the present invention by the ultra-low volume method or to inject the application form or the capsule suspensions in accordance with the present invention themselves into the soil.

A preferred direct treatment of the plants is foliar use, that is to say the capsule suspensions in accordance with the present invention are applied to the foliage, in which case the treatment frequency and the application rate should be adjusted according to the level of infestation with the pest concerned.

In the case of active ingredients having systemic activity, the capsule suspensions in accordance with the present invention also get into the plants via the root system. The treatment of the plants then proceeds through the action of the capsule suspensions in accordance with the present invention on the habitat of the plant. This can be accomplished, for example, by drenching or by mixing into the soil or into the nutrient solution, that is to say the locus of the plant (e.g. soil or hydroponic systems) is impregnated with a liquid form of the capsule suspensions in accordance with the present invention, or by soil application, that is to say the capsule suspensions according to the invention in accordance with the present invention are introduced into the locus of the plants in solid form (for example in the form of granules) or by drip application (often also referred to as “chemigation”), that is to say the capsule suspensions according to the invention in accordance with the present invention are introduced at defined locations in the vicinity of the plants via surface or underground drip lines over certain periods of time together with varying amounts of water. In the case of paddy rice crops, this can also be accomplished by metering the compound of the formula (I) in a solid application form (for example as granules) into a flooded paddy field.

The soil application of the capsule suspensions according to the invention in accordance with the present invention is the preferred form of application.

In an alternative embodiment, the capsule suspensions according to the invention are applied in a foliar use.

The capsule suspension concentrates according to the invention are of excellent suitability for the application to plants and/or to the habitat thereof of the agrochemical active ingredients that are present. They ensure the release of the active components in the respective desired amount over a relatively long period of time. The capsule suspension concentrates according to the invention can be routinely used either as is or after prior dilution with water.

Application is effected by customary methods, i.e., for example by pouring, spraying or atomization.

The application rate of capsule suspension concentrates according to the invention may be varied within a relatively wide range. It is guided by the agrochemical active ingredients concerned and by the content thereof in the microcapsule formulations.

The capsule suspension concentrates according to the invention can be produced by known processes, for example as mixed formulations of the individual components, optionally with further active ingredients, additives and/or customary formulation auxiliaries, and these are then applied in a customary manner diluted with water, or produced as tankmixes by joint dilution of the separately formulated or partly separately formulated individual components with water. Likewise possible is application at different times (split application) of the separately formulated or partly separately formulated individual components. It is also possible to apply the individual components or the capsule suspension concentrates according to the invention in more than one portion (sequential application).

The invention is illustrated by the examples below.

### EXAMPLES

1. Production of the CS Formulation

Production of the organic phase: The active ingredient was dissolved in the organic solvent while stirring, with optional admixture of further additives. The polyisocyanate was then added in the defined ratio.

Production of the aqueous phase: The protective colloid was dissolved in water and the defoamer then added.

The organic phase was added to the aqueous phase and emulsified with the aid of a rotor/stator mixing tool (UltraTurrax) until the desired particle size had been attained. Optionally, the amine component was additionally added to the emulsion. The mixture was heated to approx. 70° C. for approx. 4 h to ensure complete reaction of the wall-forming polyurea.

The mixture was then cooled to room temperature and biocides and thickener added to adjust the desired viscosity. Optionally, ammonia was added to ensure all the isocyanate had reacted.

The particle size of the final capsules was determined by laser diffraction (Malvern Mastersizer).

| | # | | | | | | | |
|---|---|---|---|---|---|---|---|---|
| | 1 | 2 | 3 | 4 | 8 | 9 | 10 | 11 |
| Conc. | CS075 | CS050 | CS075 | CS100 | CS075 | CS075 | CS075 | CS075 |
| Deltamethrin | 7.4 | 4.9 | 7.4 | 9.8 | 7.4 | 7.4 | 7.4 | 7.4 |
| Break-Thru Vibrant | 3 | 3.1 | 3 | 3.1 | 3 | 3 | 3 | 3 |
| Breakthru S240 | | | | | | | | |
| Synergen W 06 | | | | | | | | |
| Genapol EP 2584 | | | | | | | | |
| Desmodur 44V 20 L | 0.79 | 0.91 | 0.88 | 0.91 | 0.88 | 0.79 | 2.03 | 3.85 |
| DETA | 0.098 | | | | | 0.098 | 0.25 | 0.95 |
| Silcolapse 426 R | | 0.02 | 0.02 | 0.02 | 0.03 | 0.01 | 0.01 | 0.028 |
| Silfoam SRE | 0.03 | | | | | | | |
| Xanthan gum | 0.16 | 0.2 | 0.2 | 0.16 | 0.46 | 0.2 | 0.2 | 0.2 |
| Proxel GXL + Kathon CG/ICP | 0.23 | 0.19 | 0.19 | 0.19 | 0.19 | 0.19 | 0.19 | 0.19 |
| Kuraray Poval 26-88 | 0.49 | | | | 0.46 | 0.45 | 0.45 | 0.41 |
| Borresperse NA | | 0.44 | 0.46 | 0.46 | | | | |
| Ammonia 24-30% | 0.008 | | | | | | | |
| Water | 56.7 | 53.7 | 55 | 53.7 | 55 | 54.8 | 53.6 | 51.1 |
| Solvesso 200 ND | 30.9 | 36.6 | 32.9 | 31.7 | 32.9 | 32.9 | 32.9 | 32.9 |
| Particle size d₅₀/d₉₀ [μm] | | 4.1/12.6 | a*: 4.8/13.7 | 5.0/20.6 | a*: 3.1/6.3 | 3.1/6.4 | 2.1/6.7 | 5.1/10.6 |
| | | | b: 13.4/25.7 | | b: 4.5/ 8.9 | | | |
| Greenhouse tests | x | x | x | x | x | x | | x |
| Field tests | | | x | | x | x | x | x |

| | # | | | | | | | | |
|---|---|---|---|---|---|---|---|---|---|
| | 12 | 14 | 17 | 18 | 19 | 20 | 21 | 22 | 23 |
| Conc. | CS075 | CS075 | CS075 | CS075 | CS075 | CS075 | CS075 | CS075 | CS075 |
| Deltamethrin | 7.4 | 7.4 | 7.4 | 7.4 | 7.4 | 7.4 | 7.4 | 7.4 | 7.4 |
| Break-Thru Vibrant | 3 | 3 | | 1 | | 2 | 5 | | |
| Breakthru S240 | | | | | 3 | | | | |
| Synergen W 06 | | | | | | | | 3 | |
| Genapol EP 2584 | | | | | | | | | 3 |
| Desmodur 44V 20 L | 0.71 | 0.79 | 0.88 | 0.88 | 0.88 | 0.88 | 0.88 | 0.88 | 0.88 |
| DETA | 0.18 | 0.1 | | | | | | | |
| Silcolapse 426 R | 0.01 | 0.02 | 0.029 | 0.02 | 0.02 | 0.02 | 0.02 | 0.02 | 0.02 |
| Silfoam SRE | | | | | | | | | |
| Xanthan gum | 0.2 | 0.2 | 0.2 | 0.2 | 0.2 | 0.2 | 0.2 | 0.2 | 0.2 |
| Proxel GXL + Kathon CG/ICP | 0.19 | 0.19 | 0.19 | 0.19 | 0.19 | 0.19 | 0.19 | 0.19 | 0.19 |
| Kuraray Poval 26-88 | 0.45 | | 0.45 | | | | | | |
| Borresperse NA | | 0.46 | 0.5 | 0.46 | 0.46 | 0.46 | 0.46 | 0.46 | 0.46 |
| Ammonia 24-30% | | | | | | | | | |
| Water | 55 | 55 | 54.5 | 55 | 55 | 55 | 55 | 55 | 55 |
| Solvesso 200 ND | 32.9 | 32.9 | 35.9 | 34.9 | 32.9 | 33.9 | 30.9 | 32.9 | 32.9 |
| Particle size d₅₀/d₉₀ [μm] | 2.4/5.3 | 4.7/12.9 | 15.4/27.5 | 6.8/33.7 | 3.4/17.8 | 5.3/22.1 | 6.4/35.7 | 2.6/7.3 | 4/20.7 |
| Greenhouse tests | x | x | x | x | x | x | x | x | x |
| Field tests | | | | | | | | | |

*a/b means that two samples of different particle size were intentionally prepared with the same recipe.

| | # | | | | | | | |
|---|---|---|---|---|---|---|---|---|
| | 5 | 6 | 7 | 13 | 15 | 16 | 24 | 25 |
| Conc. | CS075 | CS075 | CS075 | CS075 | CS075 | CS075 | CS075 | CS075 |
| Deltamethrin | | | | 7.4 | 7.4 | 7.4 | 7.4 | 7.4 |
| Beta-cyfluthrin | | | 7.4 | | | | | |
| Cypermethrin | | 7.4 | | | | | | |
| Lambda-cyhalothrin | 7.4 | | | | | | | |
| Break-Thru Vibrant | 3 | 3 | 3 | 3 | 3 | 3 | | |
| Genapol X 060 | | | | | | | 2 | |
| Genapol XM 060 | | | | | | | | 2 |
| Genapol EP 2584 | | | | | | | | |
| Desmodur 44V 20 L | 0.88 | 0.88 | 0.88 | | | | 0.88 | 0.88 |
| Desmodur T 80 | | | | 0.88 | | | | |
| Desmodur N 3800 | | | | | 0.85 | 0.81 | | |
| DETA | | | | | 0.04 | 0.07 | | |
| Silcolapse 426 R | 0.02 | 0.02 | 0.02 | 0.03 | 0.02 | 0.02 | 0.02 | 0.02 |
| Xanthan gum | 0.2 | 0.2 | 0.2 | 0.2 | 0.2 | 0.2 | 0.2 | 0.2 |
| Proxel GXL + Kathon CG/ICP | 0.19 | 0.19 | 0.19 | 0.19 | 0.19 | 0.19 | 0.19 | 0.19 |
| Kuraray Poval 26-88 | | | | 0.46 | | | | |
| Borresperse NA | 0.46 | 0.46 | 0.46 | | 0.48 | 0.48 | 0.46 | 0.46 |
| Water | 55 | 55 | 55 | 55 | 55 | 55 | 55 | 55 |
| Solvesso 200 ND | 32.9 | 32.9 | 32.9 | 32.9 | 32.9 | 32.9 | 33.9 | 33.9 |
| Particle size d₅₀/d₉₀ [μm] | 8.3/24.3 | 7.9/22.3 | 6.1/17.8 | 2.9/6.1 | 4.6/8.9 | 3.5/8.7 | 3.3/9.8 | 8.3/22.5 |
| Greenhouse tests | x | x | x | x | x | x | x | x |
| Field tests | | | | | | | | |

| | # | | | | | | |
|---|---|---|---|---|---|---|---|
| | 26 | 27 | 28 | 29 | 30 | 31 | 32 |
| Conc. | CS075 | CS075 | CS075 | CS075 | CS075 | CS075 | CS075 |
| Deltamethrin | 7.4 | 7.4 | 7.4 | 7.4 | 7.4 | 7.4 | 7.4 |
| Beta-cyfluthrin | | | | | | | |
| Cypermethrin | | | | | | | |
| Lambda-cyhalothrin | | | | | | | |
| Break-Thru Vibrant | | | 1 | 2 | 3 | 0.5 | 3 |
| Genapol X 060 | | | | | | | |
| Genapol XM 060 | | | | | | | |
| Genapol EP 2584 | 2 | | | | | | |
| Desmodur 44V 20 L | 0.88 | 0.79 | 0.88 | 0.88 | 0.88 | 0.88 | 2.03 |
| Desmodur T 80 | | | | | | | |
| Desmodur N 3800 | | | | | | | |
| DETA | | 0.1 | | | | | 0.25 |
| Silcolapse 426 R | 0.02 | 0.02 | 0.02 | 0.02 | 0.02 | 0.02 | 0.02 |
| Xanthan gum | 0.2 | 0.2 | 0.2 | 0.2 | 0.2 | 0.2 | 0.2 |
| Proxel GXL + Kathon CG/ICP | 0.19 | 0.19 | 0.19 | 0.19 | 0.19 | 0.19 | 0.19 |
| Kuraray Poval 26-88 | | 0.45 | 0.46 | 0.46 | 0.46 | | |
| Borresperse NA | 0.46 | | | | | 0.45 | 0.44 |
| Water | 55 | 55 | 55 | 55 | 55 | 55 | 53.6 |
| Solvesso 200 ND | 33.9 | 35.9 | 34.9 | 33.9 | 32.9 | 35.4 | 32.9 |
| Particle size d₅₀/d₉₀ [μm] | 6.1/16.3 | 10.5/18.9 | 4.9/10 | 4.6/8.9 | 3.6/7.3− | 8.5/29 | 5.4/9.6 |
| Greenhouse tests | x | | | | | | x |
| Field tests | | | | | | | |

2. Testing of Different Formulation Types in the Greenhouse

### DESCRIPTION OF THE METHOD

Activity tests were carried out in long plastic containers filled with 5.9 kg of pH 7.1 sandy loam soil containing 1.8% humus. A furrow 5 cm deep was formed and four maize seeds (Ronaldino variety) were placed therein 7 cm apart. The test formulations were diluted in 4 ml of tap water and mixed homogeneously with 700 g of sandy loam soil. The treated soil was used to fill the open furrow and to cover the seeds, which resulted in a total soil weight of 6.6 kg per container. Infestation with 450 Diabrotica balteata eggs per container was carried out by pipette one day after sowing. The soil moisture content was adjusted to 50% of the specific field capacity and increased to 80% once the first hatched Diabrotica balteata larvae had appeared. The growth conditions were at a constant temperature of 25° C., 60-70% relative humidity and 14 h illumination with sodium vapour lamps. The test setup comprised three replicates per treatment. The tests were assessed 21 days after infestation by counting the number of damaged plants and measuring the fresh shoot weights per container.

Because the absolute numbers can vary greatly from one test series to the next, the tables in all cases show only results that were also carried out in a parallel test. Where appropriate, as two or more tables with the respective reference results are indicated.

Comparison of different formulation types:

| # | 1 | N1 | N2 | N3 | N4 |
|---|---|---|---|---|---|
| Name | | K-Othrine | Decis Forte | GR0.4 | GR0.4 |
| | | SC025 | EC100 | | |
| | | (commercial | (commercial | | |
| | | product) | product) | | |

| | | |
|---|---|---|
| Deltamethrin | 0.4 | 0.4 |
| Propylene glycol | 0.27 | |
| Biodac 30/60 | 99.2 | 96 |
| Citric acid | 0.003 | |
| Lucramul PS 29 | 0.13 | |
| Lucramul Hot 5902 | | 0.12 |
| Ruetasolv Di | | 3.48 |
| Antifoam | 0.003 | |

| # | Healthy plants/% |
|---|---|
| 1 | 83.3 |
| N1 | 25.0 |
| N2 | 44.4 |
| N3 | 0.0 |
| N4 | 0.0 |
| UTC not infested | 100 |
| UTC infested | 0.0 |

Formulation #1 according to the invention shows markedly better activity than all comparative examples.

3. Comparison of Different CS Recipes

(Unless otherwise stated, the following test conditions applied: DLT application conditions always 60 g/ha, observation period 21 days after infestation)
a. Concentration of AI

| # | Healthy plants/% | Shoot weight/g |
|---|---|---|
| 2 | 100 | 89.7 |
| 3 | 100 | 91 |
| 4 | 100 | 84.7 |
| UTC not infested | 100 | 79.7 |
| UTC infested | 0 | 29.3 |

The AI concentration in the formulation can be varied at the same active ingredient application rate with equally good activity.
b. Different Active Ingredients
Comparison of the formulation according to the invention vs. commercial products (capsule suspension or granules) of lambda-cyhalothrin, beta-cyfluthrin, cypermethrin

| | Shoot weight/g | | | |
|---|---|---|---|---|
| # | 5 g ai/ha | 10 g ai/ha | 30 g ai/ha | 60 g ai/ha |
| 5 | 10.2 | 13.6 | 15.0 | 12.7 |
| Lambda-cyhalothrin CS100 | 7.0 | 4.4 | 6.5 | 9.6 |
| (Karate Zeon) | | | | |
| Lambda-cyhalothrin GR0.4 | 8.2 | 10.0 | 11.7 | 14.9 |
| 6 | | 9.7 | 14.2 | 14.2 |
| Beta-cyfluthrin GR0.4 | | 7.2 | 7.5 | 11.3 |
| 7 | | 7.9 | 14.7 | 15.4 |
| Cypermethrin MG0.8 (Belem) | | 6.3 | 7.0 | 6.8 |

| | |
|---|---|
| UTC not infested | 9.9 |
| UTC infested | 1.7 |

All formulations according to the invention show at least comparable, mostly markedly better, effectiveness at the same AI application rate as the commercial products of the same active ingredient.
c. Composition of Capsule Shell
Formulations according to the invention having varying capsule thicknesses, isocyanate types, crosslinking and protective colloids are tested hereinbelow.

| # | Healthy plants/% | Shoot weight/g |
|---|---|---|
| 8 | 33.3 | 38.8 |
| UTC not infested | 100 | 36.4 |
| UTC infested | 0 | 13.6 |

| # | Healthy plants/% | Shoot weight/g |
|---|---|---|
| 3 | 66.7 | 41.2 |
| 9 | 16.7 | 42.2 |
| 10 | 1.0 | 28.0 |
| 11 | 1.0 | 14.86 |
| 12 | 0.0 | 31.6 |
| 13 | 25.0 | 39.2 |
| UTC not infested | 100 | 34 |
| UTC infested | 0 | 21.6 |

| # | Healthy plants/% | Shoot weight/g |
|---|---|---|
| 9 | 83.3 | 72.8 |
| 3 | 83.3 | 71.8 |
| 14 | 66.7 | 67.0 |
| UTC not infested | 100 | 72.2 |
| UTC infested | 8 | 26.2 |

| # | Healthy plants/% | Shoot weight/g |
|---|---|---|
| 3 | 100 | 26.4 |
| 15 | 100 | 37 |
| 16 | 100 | 39.3 |
| UTC not infested | 100 | 27.4 |
| UTC infested | 8 | 15.7 |

All formulations according to the invention show activity. The activity after 21 days is strongly dependent on the nature of the capsule shell. The required release profile can accordingly be adjusted through appropriate selection of the shell composition or by mixing different formulations.
d. Type and amount of adjuvant

| # | Healthy plants/% | Shoot weight/g |
|---|---|---|
| 17 | 66.7 | 63.3 |
| 18 | 91.7 | 81.7 |
| 1 | 100 | 91.0 |
| 19 | 100 | 88.7 |
| UTC not infested | 100 | 79.7 |
| UTC infested | 0 | 29.3 |

| # | Healthy plants/% | Shoot weight/g |
|---|---|---|
| 20 | 100 | 28.7 |
| 21 | 100 | 36.3 |
| 22 | 100 | 38.0 |
| 23 | 100 | 36.7 |
| 10 + BT V tankmix | 16.7 | 21.3 |
| UTC not infested | 100 | 40.7 |
| UTC infested | 8.3 | 17.0 |

| # | Healthy plants/% | Shoot weight/g |
|---|---|---|
| 20 | 100 | 30.6 |
| 24 | 100 | 41.1 |
| 25 | 25 | 36.7 |
| 26 | 100 | 45.2 |
| UTC not infested | 100 | 27.4 |
| UTC infested | 8 | 15.7 |

It was surprisingly found that the adjuvant needs to be present for optimal activity in the capsule, while tankmix additives do not show adequate activity. Moreover, adjuvants having terminal hydroxyl functionality show even better activity than those with methoxy functionality.
Optical assessment of the capsule suspensions under the microscope after drying of the formulation:

| | 0% BreakThru | 0.5% | 1% | 2% | 3% |
|---|---|---|---|---|---|
| Protective colloid | Vibrant | BT V | BT V | BT V | BT V |
| Kuraray Poval 26-88 | #27: − | | #28: − | #29: o | #30: + |
| Borresperse NA | | #31: − | #18 − | #20: o | #3: + |

Assessment scheme:
− = poor,
o = borderline,
+ = good

e. Influence of soil conditions
1. Standard soil, 2. Standard soil+20% peat;

| | Healthy plants/% | | Shoot weight/g | |
|---|---|---|---|---|
| # | 1. Standard soil | 2. +20% peat | 1. Standard soil | 2. +20% peat |
| 3 | 100 | 91.7 | 36.3 | 30.7 |
| 8 | 100 | 100 | 35.3 | 39.0 |
| UTC not | 100 | 100 | 40.7 | 42.7 |
| infested | | | | |
| UTC | 8.3 | 16.7 | 17.0 | 17.7 |
| infested | | | | |

It was surprisingly found that the activity is independent of the soil composition.
Soil Moisture Content
Application scenarios:
A) Formulation according to the invention is introduced into uppermost soil layer (approx. 40-50% water-retention capacity)=standard
B) Formulation according to the invention is introduced into uppermost soil layer (approx. 40-50% water-retention capacity) and stored for 7 days under damp conditions.
C) Formulation according to the invention is introduced into uppermost soil layer (approx. 40-50% water-retention capacity) and the treated soil was dried for 7 days (<20% water-absorption capacity).
D) Soil was dried for 7 days (<20% water-absorption capacity), the formulation according to the invention applied into the dried soil and then renewed watering carried out after sowing.

| | Healthy plants/% | | | | Shoot weight/g | | | |
|---|---|---|---|---|---|---|---|---|
| # | A) | B) | C) | D) | A) | B) | C) | D) |
| 3 | 91.7 | 100 | 100 | 83.3 | 24.0 | 25.3 | 21.3 | 20.0 |
| 8 | 100 | 100 | 100 | 100 | 21.3 | 21.7 | 22.3 | 19.0 |

| | | |
|---|---|---|
| UTC not | | 19.0 |
| infested | | |
| UTC infested | 0 | 5.7 |

It was surprisingly found that the activity is independent of the soil moisture conditions.
f. Comparison with Commercial Product

| # | Healthy plants/% | Shoot weight/g |
|---|---|---|
| 9 | 83.3 | 72.8 |
| DelCaps CS050 | 4.2 | 32.5 |
| UTC not infested | 100 | 72.2 |
| UTC infested | 8 | 26.2 |

With soil application, the commercial product shows markedly poorer activity than the formulation according to the invention.
g. Influence of Particle Size in Different Batches of the Same Recipe

| # | Healthy plants/% | Shoot weight/g |
|---|---|---|
| 3a | 100 | 61.2 |
| 3b | 100 | 67.1 |
| 8a | 100 | 63.7 |
| 8b | 100 | 67.6 |
| UTC not infested | 100 | 69.7 |
| UTC infested | 0 | 34.1 |

Relatively small variations in particle size have no influence on the activity.

4. Outdoor Trials
The formulations according to the invention were tested in outdoor trials versus Belem GR (active ingredient: cypermethrin) as standard against wireworm in maize. The capsule formulations were sprayed (in furrow spray application) at an application rate of 60 g a.i./ha. (comparison Belem MG 0.8 is applied at 96 g a.i./ha) into the seed furrow.
The reported activity is the mean of 4 individual results.

| # | Activity/% |
|---|---|
| Untreated | 46.9 |
| 8 | 73.8 |
| 3 | 75.7 |
| 9 | 70.7 |
| 10 | 62.0 |
| 11 | 45.9 |
| 8 + 11 | 65.0 |
| Belem | 61.3 |
| MG 0.8 | |

The formulations according to the invention show better activity compared with the standard. In addition, the release rate can be adjusted by mixing two formulations having different release (#8+#11). This results in an average activity.

5. Foliar Application
The formulations according to the invention were tested pre-infested in the greenhouse on
   Myzus persicae (MYZUPE) on cabbage (Melissa) and bell peppers (Feher);
   Aphis gossypii (APHIGO) on cotton (Viky);
with mixed populations.
The application concentration was 400 1/ha with a track sprayer. Three replicates were in each case carried out. The tests with MYZUPE were carried out at 20° C. and with APHIGO at 23° C.
Evaluation was after 1, 4 and 7 days (1, 4, 7 d) after application.
Application rate: track sprayer with 400 1/ha, contact, in each case three replicates

| | Application | % mortality of Myzus persicae | | | % mortality of Myzus persicae | | | % mortality of Aphis gosypii on | | |
|---|---|---|---|---|---|---|---|---|---|---|
| | concentration | on bell pepper | | | on cabbage | | | cotton | | |
| | g a.i./ha | 1 d | 4 d | 7 d | 1 d | 4 d | 7 d | 1 d | 4 d | 7 d |
| N1 | 4.8 | 23 | 27 | 37 | 37 | 40 | 37 | 23 | 50 | 40 |
| | 0.96 | 10 | 10 | 3 | 10 | 10 | 0 | 7 | 7 | 3 |
| | 0.19 | 0 | 0 | 0 | 0 | 0 | 0 | 0 | 0 | 0 |
| | 0.038 | 0 | 0 | 0 | 0 | 0 | 0 | 0 | 0 | 0 |
| 32 | 4.8 | 87 | 99 | 100 | 77 | 97 | 97 | 70 | 89 | 89 |
| | 0.96 | 60 | 73 | 83 | 63 | 67 | 40 | 47 | 83 | 83 |
| | 0.19 | 20 | 20 | 23 | 20 | 13 | 3 | 13 | 23 | 10 |
| | 0.038 | 0 | 0 | 0 | 0 | 0 | 0 | 3 | 3 | 0 |

The formulation according to the invention shows better activity than SC025 (N1)

Materials Used

Deltamethrin is an active substance from Bayer AG, Leverkusen.

Beta-cyfluthrin is an active substance from Bayer AG, Leverkusen.

Cypermethrin was obtained from Agros Organics BVBA, Geel, Belgium.

Break-Thru® Vibrant is a nonionic organic surfactant from Evonik Industries AG, Essen.

Breakthru® S240 is a polyether-modified trisiloxane from Evonik Industries AG, Essen.

Synergen W 06 is a fatty alcohol alkoxylate from Clariant Produkte (Deutschland) GmbH, Frankfurt.

Genapol EP 2584 is a fatty alcohol alkoxylate from Clariant Produkte (Deutschland) GmbH, Frankfurt.

Genapol X-060 is a fatty alcohol polyglycol ether from Clariant Produkte (Deutschland) GmbH, Frankfurt.

Genapol XM 060 is a fatty alcohol polyglycol ether having terminal methyl group based on Genapol X-060 from Clariant Produkte (Deutschland) GmbH, Frankfurt.

Desmodur® 44V 20 L is a mixture of polymeric isocyanates based on diphenylmethane 4,4′-diisocyanate from Covestro AG, Leverkusen.

Desmodur® T80 is a TDI (toluene diisocyanate) mixture from Covestro AG, Leverkusen.

Silcolapse® 426 R is a defoamer from Elkem Silicones Germany GmbH, Libeck.

Silfoam® SRE is a defoamer from Wacker Chemie AG, Munich.

Kuraray Poval® 26-88 is a partially saponified polyvinyl alcohol from Kuraray Europe GmbH, Hattersheim.

Borresperse® NA is a lignosulfonate from Borregaard, Sarpsborg, Norway.

Standard Chemicals:

Xanthan gum is a thickener for aqueous systems (various suppliers).

The biocides which can be used are all commercial available and licensed biocides, examples include Proxel® GXL from Lonza and Kathon™ CG/ICP from Dupont.

Solvesso 200 ND is an aromatic hydrocarbon (various suppliers).

Diethylenetriamine and ammonia are standard chemicals and may be obtained from various suppliers.

Comparison Products:

DelCaps 050 CS is a product containing encapsulated deltamethrin from INNVIGO, Warsaw, Poland.

BELEM® 0.8 MG is a commercial product containing cypermethrin as active ingredient.

1. A capsule suspension concentrate comprising
A) a particulate disperse phase comprising
1) a reaction product of at least one compound having isocyanate-reactive groups a1.1) and an isocyanate or isocyanate mixture a1.2)
2) a pyrethroid a2.1) in an organic, water-insoluble solvent a2.2),
3) one or more additives a3.1)
and
B) a liquid aqueous phase comprising at least one protective colloid b1.1) and optionally one or more further additives b1.2),
wherein the particles of the disperse phase A) optionally have a median particle size of between 1 and 50 μm, and wherein
the proportion of a1.2) is between 0.1% and 2% by weight,
the proportion of a2.1) is between 1% and 50% by weight,
the proportion of organic solvent a2.2) is between 1% and 90% by weight,
the proportion of additive a3.1) is between 0.5% and 5% by weight,
the proportion of protective colloid b1.1) is between 0.1% and 5% by weight, and
the proportion of additive b1.2) is between 0.1% and 15% by weight.

2. The capsule suspension concentrate according to claim 1, wherein the pyrethroid is selected from the group consisting of deltamethrin, beta-cyfluthrin, cypermethrin and lambda-cyhalothrin.

3. The capsule suspension concentrate according to claim 1, wherein component a3.1) comprises at least one compound selected from the group comprising alkyl ethoxylates, alkyl propoxy ethoxylates, fatty acid esters of sorbitan and glycerol, and organomodified trisiloxanes.

4. The capsule suspension concentrate according to claim 1, wherein component a1.1) is water.

5. The capsule suspension concentrate according to claim 1, wherein particles of the disperse phase A) have a median particle size of between 2 and 15 μm.

6. The capsule suspension concentrate according to claim 1, wherein the proportion of a1.2) is between 0.5% and 2.0% by weight,
the proportion of a2.1) is between 5% and 15% by weight,
the proportion of organic solvent a.2.2) is between 25% and 40% by weight,
the proportion of additive a3.1) is between 2% and 5% by weight,
the proportion of protective colloid b1.1) is between 0.2% and 1% by weight and
the proportion of additive b1.2) is between 0.3% and 3% by weight.

7. The capsule suspension concentrate according to claim 1, wherein the ratio of a2.1) to the isocyanate or isocyanate mixture is between 2:1 and 10:1.

8. The capsule suspension concentrate according to claim 1, wherein the ratio of a1.2) to optionally phase A) is 40:1 to 60:1, optionally 45:1 to 60:1, optionally 45:1-55:1.

9. The capsule suspension concentrate according to claim 1, wherein the organic solvent (a2.2) is selected from the group comprising dialkyl naphthalenes and also a mixture of 1-methyl- and 2-methylnaphthalene and naphthalene.

10. The capsule suspension concentrate according to claim 1, wherein the proportion of phase A) based on the overall formulation is between 30% and 70% by weight.

11. The capsule suspension concentrate according to claim 1, wherein the proportion of a2.1) based on the overall formulation is between 5% and 15% by weight.

12. A process for preparing the capsule suspension concentrate according to claim 1, comprising:
1. producing the phase A)
2. producing the aqueous phase B)
3. producing an emulsion of A) in B)
4. optionally adding component a1.1) (when a1.1. is not water)
5. heating
6. finalizing.

13. A product comprisinq the capsule suspension concentrate according to claim 1 for foliar application.

14. A product comprisinq the capsule suspension concentrate according to claim 1 for soil application.

15. The product according to claim 14, wherein release takes place over a relatively long period of time.

16. The capsule suspension concentrate according to claim 1 for soil application of pyrethroid, optionally of deltamethrin.
